(19) United States
(12) Patent Application Publication
(10) Pub. No.: US 2026/0098518 A1
(43) Pub. Date: Apr. 9, 2026

(54) ASSEMBLY AND METHOD FOR CONNECTING A STEEL WIND TURBINE TOWER TO A CONCRETE FOUNDATION

(71) Applicant: EQUINOR ENERGY AS, Stavanger (NO)

(72) Inventor: Herbjørn HASLUM, Bekkestua (NO)

(21) Appl. No.: 19/115,595

(22) PCT Filed: Sep. 27, 2023
(86) PCT No.: PCT/NO2023/060057

§ 371 Date: Mar. 26, 2025

(30) Foreign Application Priority Data
Sep. 28, 2022 (GB) 2214213.7

(51) Int. Cl. F03D 13/20; E02D 27/42; F03D 13/25

(52) U.S. Cl. CPC F03D 13/206; E02D 27/425; F03D 13/256

(57) ABSTRACT

A cable head ring for use in connecting a wind turbine tower to a concrete foundation. The cable head ring includes an annular plate for connecting to the upper end of the concrete foundation, an inner tubular web extending axially from the annular plate and an outer tubular web extending axially from the annular plate. An annular gap is formed between the inner and outer tubular webs for receiving a tubular wind turbine component. The annular plate has a plurality of passages extending axially therethrough for receiving tensioning tendons of the concrete foundation. The inner and outer tubular webs include holes extending radially therethrough. The positions of the holes in the inner tubular web correspond to the positions of the holes in the outer tubular web such that a fastener can extend radially through a hole in the inner tubular web and a hole in the outer tubular web.

The present invention relates to an assembly and method for connecting a tubular structure to a tubular concrete structure, and in particular to an assembly and method for connecting a tubular wind turbine component to a tubular concrete foundation.

Floating platforms, for example spar buoys, are often used to support offshore wind turbines in deep waters where it is not possible or financially viable to use fixed foundation structures. Spar buoys are vertically elongate buoyant structures that can be used for supporting offshore wind turbines. They are tubular structures with walls that are often made of concrete, e.g. prestressed concrete, that can be formed using a slip forming construction technique which provides a relatively straightforward and cost-effective means of manufacturing the structure.

It is important that the connection between a tubular, often steel, wind turbine tower and a tubular concrete foundation, such as a spar buoy, can withstand the often large moments and associated horizontal and vertical forces that are experienced during assembly and continued operation. These forces are typically greater for floating wind turbines compared to fixed foundation turbines, due to the movement of the floating wind turbine structure in the water. Known processes for assembling such a connection can be challenging since they often require high levels of precision to meet strict tolerances.

Patent document NO 345416 B1 describes an assembly for connecting a tubular steel structure to a tubular concrete structure that includes prestressing cables protruding from an upper end thereof. In the assembly, an anchor ring having a number of cable holes and bolt holes is adhered to the upper end of the concrete structure using a layer of grout. The prestressing cables are passed through the cable holes provided in the anchor ring, and the anchor ring is secured to the concrete structure by anchors that are locked to the cables on the upper side of the anchor ring after the cables have been tensioned. A levelling ring having bolt holes corresponding with the bolt holes in the anchor ring is adhered to the upper surface of the anchor ring using another layer of grout.

In order to mount the tubular steel structure to the concrete structure, a T-flange having bolt holes corresponding to those in the anchor ring and levelling ring is welded to the lower end of the tubular steel structure. The T-flange is secured to the concrete structure with bolts that pass though the bolt holes in the T-flange, the levelling ring and the anchor ring and are secured in place using nuts.

This known assembly technique requires a large number of bolts to secure the T-flange to the concrete structure, which can lead to a lengthy and costly installation process. Similarly, applying the grout to adhere the components together can be a lengthy operation. It can also be difficult to fabricate the bolt holes through the T-flange, anchor ring and levelling plate to the tolerances required to permit the bolts to pass therethrough. The T-flange itself also presents manufacturing difficulties, in particular for larger steel components (e.g. having diameters in excess of around 10 m) where it can be difficult or even impossible with today's manufacturing techniques to fabricate a suitably large T-flange.

Moreover, there are several points of weakness in this known assembly.

The weld between the T-flange and the steel component is susceptible to fatigue, substantially more so than a weld between two tubular components. This is a result of the shape of the T-flange, which exerts stress on the weld. The known assembly also utilises a relatively thick layer of grout to adhere the levelling ring to the anchor ring. Whilst this permits the use of longer bolts, it is relatively structurally weak.

According to a first aspect of the invention there is provided a cable head ring for use in connecting a wind turbine tower to a concrete foundation, the cable head ring comprising: an annular plate for connecting to the upper end of a concrete foundation, the annular plate comprising a plurality of passages extending axially therethrough for receiving tensioning tendons of the concrete foundation; an inner tubular web extending axially from the annular plate; and an outer tubular web extending axially from the annular plate, the outer tubular web having a larger radius than the inner tubular web so that an annular gap is formed between the inner and outer tubular webs for receiving a tubular wind turbine component; wherein the inner tubular web includes holes extending radially therethrough, and the outer tubular web includes holes extending radially therethrough, and wherein the positions of the holes in the inner tubular web correspond to the positions of the holes in the outer tubular web such that a fastener can extend radially through a hole in the inner tubular web and a hole in the outer tubular web for securing a tubular wind turbine component within the annular gap.

It will be appreciated that the holes in the inner tubular web and the holes in the outer tubular web are fastener receiving holes suitable for receiving fasteners therethrough.

The cable head ring forms a forked structure with a substantially U-shaped cross-section. The annular gap between the inner and outer webs provides a space into which a tubular wind turbine component can be received. The holes in the inner and outer webs provide anchoring points for fasteners that may be used to secure a wind turbine component to the cable head ring. This assembly avoids the need for welding a T-flange onto the lower end of the wind turbine component for securing the wind turbine component to a concrete foundation, removing a point of weakness in the structure.

Tubular webs may also extend axially from the annular plate opposite the inner and outer tubular webs. In that case, the cable head ring may have a substantially H-shaped cross-section.

The annular plate may also be referred to as a flange or an anchor ring.

The radially extending holes in the inner and outer tubular webs will, in use, extend substantially horizontally through the inner and outer webs.

Each hole in the inner tubular web or each hole in the outer tubular web may be aligned with a respective hole in the other of the outer tubular web or the inner tubular web such that a single fastener can extend radially (i.e. along a radius of the cable head ring) through both a hole in the inner tubular web and a hole in the outer tubular web. For example, for n holes in the inner tubular web, there would be n corresponding holes in the outer tubular web so that n fasteners could each extend through a hole in the inner tubular web and a corresponding hole in the outer tubular web, respectively.

Each hole in the inner tubular web may correspond to a hole in the outer tubular web. Each hole in the outer tubular web may correspond to a hole in the inner tubular web. Put another way, the number of holes in the inner tubular web may equal (i.e. no more and no less than) the number of holes in the outer tubular web, and each hole in the inner tubular web may correspond to a hole in the outer tubular web.

Each hole in the inner tubular web corresponds to a hole in the outer tubular web, with the corresponding holes being located along a radius of the cable head ring and at the same axial location (i.e. displacement from the annular plate). In this way, a fastener passing through a hole in the inner tubular web and a hole in the outer tubular web will extend in a level (substantially horizontal), radial direction.

Each of the holes in the inner tubular web and/or the outer tubular web may be located at the same axial location (whilst being spaced apart in a circumferential direction). Hence, the holes in the inner tubular web and/or outer tubular web may be configured as a level ring around the respective web.

The holes in the inner tubular web and/or the outer tubular web may be circumferentially spaced around the respective web. In this way, a tubular structure can be fastened to the cable head ring (e.g. using fasteners passing through the holes) at a plurality of locations around the cable head ring.

The holes in the inner tubular web and/or outer tubular web may be evenly spaced around the respective web. Accordingly, the forces associated with fastening a tubular structure to the cable head ring can be evenly distributed around the cable head ring.

The holes may be any suitable shape for receiving a fastener suitable for securing a tubular structure to the cable head ring. It will be appreciated that the shape of the holes may differ depending on the type of fastener used. The holes in the inner tubular web and/or the outer tubular web may be circular holes, elliptical holes or elongated holes. Preferably, the shape of the holes in the inner tubular web corresponds to the shape of the holes in the outer tubular web. For instance, each of the holes may be a circular hole, an elliptical hole or an elongated hole, and the size of each hole may be substantially the same.

The inner and outer webs may be concentric. Accordingly, the width of the annular gap may be constant around the cable head ring.

The cable head ring may be made of steel. It may be fabricated by machining, casting, forging, and/or welding plate or curved segments together.

A lower surface of the annular plate (i.e. the surface opposite the tubular webs) may comprise a planar surface for mating with the upper end of a concrete foundation. The lower surface may be machined to provide the planar surface.

Concrete foundations for wind turbines are typically made from prestressed concrete and comprise tensioning tendons located within the concrete for applying a compressive force to the concrete structure. At least one end of each tendon may protrude from an upper end of the concrete structure so that tension can be applied to the tendon and locked in using tension anchors. The cable head ring can be used to provide a convenient seat for such tensioning anchors. The tendons and the anchors can also be used to secure the cable head ring to the concrete foundation, by passing the tendons through the passages in the annular plate and using anchors on the upper side of the plate to fasten them in place. Hence, the tension within the tendons can be used to secure the cable head ring to the concrete foundation.

The axially extending passages in the annular plate will, in use, extend substantially vertically though the cable head plate.

The locations of the passages preferably correspond to the locations of the ends of tendons protruding from a concrete foundation on which the cable head ring is intended to be mounted. The tensioning tendons are typically circumferentially spaced around the concrete foundation. Hence, the passages through the annular plate may be circumferentially spaced around the annular plate. The passages may be evenly spaced around the annular plate.

One or more or all of the passages may be located between the inner and outer tubular webs. Hence, the passages may open out into the annular gap between the inner and outer tubular webs.

Locating passages between the inner and outer tubular webs can provide a secure anchor point for the tendons and anchors that is protected from external interference, e.g. from environmental conditions outside of the tubular structure. However, it may prove difficult to tension the tendons and lock the anchors in place using the necessary equipment, which is often large and bulky, when tendons and anchors are positioned within the annular gap. It may also be difficult, or impossible, to inspect or adjust the anchors and the tendons when they are located within the annular gap.

The annular plate may extend radially inward of the inner tubular web. One or more or all of the passages may be located radially inward of the inner tubular web, i.e. through a portion of the annular plate that extends radially inward of the inner tubular web.

The annular plate may extend radially outward of the outer tubular web. One or more or all of the passages may be located radially outward of the outer tubular web, i.e. through a portion of the annular plate that extends radially outward of the outer tubular web.

It may be easier to tension the tendons and secure the anchors when the passages are located outside of the annular gap, since there will likely be more space to manoeuvre and operate the necessary equipment. It may also be easier to inspect and adjust the tendons and the anchors when the passages are located outside of the annular gap.

When the passages are located radially inward of the inner tubular web, the tendons that (in use) pass through the passages, and the associated anchors, may be protected from external environmental conditions by the tubular webs, the concrete foundation and/or the tubular portion of the wind turbine. It can also be easier and safer to inspect and adjust the tendons and anchors when they are located radially inward of the tubular webs since they will be located within a tubular structure and protected from the external environment.

The annular plate may comprise passages located radially inward of the inner tubular web and passages located radially outward of the outer tubular web. In this way, tendons can be fastened to a radially inward side of the annular plate and a radially outward side of the plate. This makes it possible to balance the forces applied to the annular plate (and the cable head ring) by the tendons (and anchors).

One or more ledges may extend from the inner and/or outer web into the annular gap for a tubular structure received in annular gap to rest on. The ledge(s) can be used to prevent a tubular structure received within the annular gap from extending to the bottom of the gap (i.e. the upper surface of the annular plate). Moreover, the ledge(s) can ensure that a tubular wind turbine structure does not rest on an anchor positioned, in use, in the annular gap. The ledges may also help to support the wind turbine structure to ease vertical stresses placed on fasteners. The placement of the ledge(s) may also help to axially align holes in the wind turbine component with the holes in the inner and outer webs during assembly.

The annular plate may be sized to match the size of a tubular concrete foundation structure on which it is intended to be mounted. The annular plate may have an outer diameter in the range 7 m to 14 m. The inner diameter of the annular plate may be 0.7 m to 1 m less than its outer diameter. Hence, the width of the annular plate may be in the range 0.7 m to 1 m. The annular plate may have a thickness in the range of 100 mm to 250 mm.

The inner and/or outer tubular webs may extend up to 1m from the annular plate, optionally up to 0.5 m from the annular plate.

The inner and/or outer tubular webs may have a thickness within the range of 100 mm to 250 mm.

The width of the annular gap may be determined by the thickness of the wall of the tubular wind turbine component that is to be received in the gap. It is preferably sized so that the wind turbine component fits closely within the gap. The annular gap may have a width in the range 100 mm to 150 mm.

The present invention may extend to a wind turbine assembly comprising the cable head ring of the first aspect. Hence, according to a second aspect of the invention there is provided a wind turbine assembly comprising: a tubular concrete foundation having tensioning tendons protruding from the upper end thereof; a cable head ring according to the first aspect mounted on the upper end of the concrete foundation, the tensioning tendons passing through the passages in the annular plate and being secured by anchors arranged on an upper surface of the annular plate; a (lower end of a) tubular wind turbine component received within the annular gap between the inner and outer tubular webs of the cable head ring, the wind turbine component comprising holes extending radially therethrough and corresponding with the holes in the inner and outer tubular webs; and fasteners extending radially through respective holes in the inner tubular web, the wind turbine component, and the outer tubular web to secure the wind turbine component to the cable head ring.

The cable head ring of the second aspect may comprise any one or more or all of the optional features described above in respect of the first aspect.

Each hole in the inner tubular web or each hole in the outer tubular web may be aligned with a respective hole in the other of the outer tubular web or the inner tubular web such that a single fastener can extend radially through both a hole in the inner tubular web and a hole in the outer tubular web. For example, for n holes in the inner tubular web, there would be n corresponding holes in the outer tubular web and n fasteners each extending through a hole in the inner tubular web and a corresponding hole in the outer tubular web, respectively.

The holes in the tubular wind turbine component are located so that when the tubular wind turbine component is positioned within the annular gap, (at least some of) the holes can be aligned with the holes in the inner and outer tubular webs. As such, a fastener can extend radially through a hole in the inner tubular web, a hole in the tubular wind turbine component, and a hole in the outer tubular web in order to secure the turbine component to the cable head ring. Each fastener will pass through a hole in the inner tubular web, a hole in the tubular wind turbine component, and a hole in the outer tubular web in a radial (substantially horizontal) direction.

Each of the holes in the wind turbine component may be located at the same axial location (i.e. at the same distance from an end of the wind turbine component). Thus, the holes may be arranged in a level ring around the turbine component.

The holes in the wind turbine component may be circumferentially spaced around the wind turbine component, optionally evenly spaced around the wind turbine component. In this way, the forces exerted on the wind turbine component and the webs of the cable head ring by the fasteners can be evenly distributed around structure.

The holes in the wind turbine component can be suitably shaped for receiving the fasteners, and this shape may differ depending on the type and form of the fasteners used. The holes in the wind turbine component may be circular holes, elliptical holes or elongated holes. Preferably, the holes in the wind turbine component are shaped and/or sized the same as the holes in the inner and/or outer tubular webs of the cable head ring.

Each tendon may pass through a separate passage in the annular plate.

A layer of grout (e.g. concrete or cement) may be provided between the (lower surface of the) annular plate and the concrete foundation. This may act to adhere the cable head ring to the concrete foundation, which can assist during assembly by adhering the cable head ring to the concrete foundation before the cable head ring is secured to the concrete foundation using the tendons and the anchors. The layer of grout may be used to provide a level planar surface for the cable head ring to be mounted on, by accounting for any undulations or imperfections at the upper end of the concrete foundation which may otherwise lead to uneven loading on the cable head ring and uneven stress concentration within the material of the cable head ring. Hence, the layer of grout may have a level (substantially horizontal) planar upper surface for the cable head ring to be mounted thereon.

The layer of grout may have a thickness of up to 100 mm, optionally up to 50 mm.

The grout may extend around (a lower portion of) the cable head ring. For instance, the grout may extend radially inwards and/or outwards of the annular plate and extend up to or above the upper surface of the annular plate. In this way, a portion of the cable head ring (e.g. the annular plate) may be surrounded by grout. The grout may extend over the anchors on the upper side of the annular plate. The grout may help to protect the cable head ring (or a portion thereof) and/or the anchors from environmental conditions. The grout may extend around (at least a portion of) the inner and/or outer tubular webs. The grout may not extend above the (lower end of) the holes in the inner and/or outer tubular webs. In this way, the fasteners within the holes can be left uncovered by grout for unobstructed inspection. The grout may extend within the annular gap, optionally covering the anchors within the annular gap (if present). Extending the grout around a portion of the cable head ring can help to improve the strength and stability of the connection.

There may be an axial clearance within the annular gap between the lower end of the tubular wind turbine component and the upper surface of annular plate (or the anchors if they are present within the annular gap). As a result, the wind turbine component may not rest on the upper surface of the annular plate (or anchors, if present within the annular gap). This may be achieved through suitable axial placement of the holes in the wind turbine component so that when the turbine component is secured to the cable head ring using the fasteners the axial clearance is present. The axial clearance may allow for inspection and maintenance of anchors and tendons that are located within the annular gap.

The lower end of the wind turbine component may rest on the ledge(s) extending into the gap from the inner and/or outer tubular webs. The ledge(s) may help to support the wind turbine component and to relieve vertical stresses placed on the fasteners by the turbine component.

Alternatively, the lower end of the wind turbine component may rest on the upper surface of the annular plate (or on the anchors, where present in the annular gap).

The tensioning tendons may be circumferentially spaced around the concrete foundation, optionally evenly spaced around the concrete foundation.

Preferably, the locations of the passages through the annular plate correspond with the locations of the tendons. Hence, the passages may be circumferentially spaced around the annular plate, optionally evenly spaced apart.

One or more or all of the tendons may extend through passages in the annular plate located between the inner and outer tubular webs. In which case, anchors may be provided within the annular gap to secure the ends of the tendons against the cable head ring. Having the anchors within the annular gap may provide a stable and balanced connection.

One or more or all of the tendons may extend through passages in the annular plate located radially inward of the inner tubular web. In which case, anchors may be provided radially inward of the inner tubular web to secure the ends of the tendons against the cable head ring. Having anchors on the radially inner side of the cable head ring may make it easier and safer to inspect the anchors and tendons, since inspection can be carried out from within the tubular structure protected from external environmental conditions.

One or more or all of the tendons may extend through passages in the annular plate located radially outward of the outer tubular web. In which case, anchors may be provided radially outward of the outer tubular web to secure the ends of the tendons against the cable head ring. Securing the anchors on the outside of the outer web (i.e. a radially outer portion of the cable head ring) may provide for a stronger connection between the cable head ring and the concrete foundation.

One or more of the tendons may extend through passages in the annular plate that are located radially inward of the inner tubular web, and one or more of the tendons may extend through passages in the annular plate that are located radially outward of the outer tubular web. Hence, anchors may be provided radially inward of the inner tubular web and anchors may be provided radially outward of the outer tubular web to secure the tendons against the cable head ring. This arrangement may help to balance the forces exerted on the annular plate (and the cable head ring) by the tendons and the anchors.

The tendons may protrude from the concrete foundation at locations that are suitable for them to be passed through the passages in the annular plate. That is, the locations of the (upper end of the) tendons may correspond to the locations of the passages in the annular plate, and vice versa.

Thus, one or more of the tendons may protrude from a radially inner region of the upper end of the concrete foundation (e.g. adjacent the inner wall of the tubular concrete foundation) for passing through passages located radially inward of the inner tubular web.

One or more of the tendons may protrude from a central region of the upper end of the concrete foundation (e.g. approximately mid-way between the inner and outer walls of the tubular concrete foundation) for passing through passages located between the inner and outer tubular webs.

One or more of the tendons may protrude from a radially outer region of the upper end of the concrete foundation (e.g. adjacent the outer wall of the tubular concrete foundation) for passing through passages located radially outward of the outer tubular web.

The concrete foundation may comprise internal ducts running axially through the concrete for the tendons to pass therethrough. The tendons may pass through the ducts for applying a compression force to the concrete. Each tendon may extend through a separate duct.

The tendons may comprise single wires, multi-wire strands, or threaded bars. They may be made from any suitable material, for instance steel (e.g. high-tensile steel), carbon fibre, aramid fibre.

The tubular wind turbine component may have an outer diameter in the range 7 m to 14 m.

The wall of the tubular wind turbine component may have a thickness within the range 90 mm to 130 mm, optionally within the range 100 mm to 110 mm.

The tubular wind turbine component may comprise (the lower end portion of) a tubular wind turbine tower. Hence, the wind turbine tower may be secured directly to the cable head ring. Alternatively, the tubular turbine component may comprise a tower extension piece. The tower extension piece may be welded to or otherwise secured to (the lower end of) a wind turbine tower. Hence, with this arrangement a wind turbine tower can be indirectly secured to the cable head ring using the tower extension piece. A tower extension piece may be used if the wall of a tubular wind turbine tower is insufficiently thick to form a secure and reliable connection with the cable head ring. This may be the case if the wall of the tubular structure, with a specified thickness, would be made too weak by the presence of radially extending holes for securing the tubular structure to the concrete foundation. Hence, the wall of the tower extension piece may be thicker than that wall of a wind turbine tower connected to the extension piece. For instance, the wall of the extension piece may be 10 mm to 20 mm thicker than the wall of the wind turbine tower.

The extension piece may have a length within the range 1 m to 2 m.

The tubular wind turbine component may be made of steel.

The wind turbine assembly may comprise a nacelle mounted on the wind turbine tower, preferably at the top of the tower. The nacelle may be rotatably mounted to the tower. A generator and its associated electronics may be housed in the nacelle.

One or more rotor blades, preferably three rotor blades, may be (rotatably) mounted to the nacelle via a rotor hub. The rotor blades may be rotatably mounted to the hub, for instance so that their pitch may be controlled. The rotor hub and the rotor blades may together form a rotor of the wind turbine. The generator may be arranged to be driven by rotation of the rotor hub.

The (upper end of the) tubular concrete foundation may have an outer diameter that is approximately (e.g. +/−0.5 m) the same as the outer diameter of the wind turbine component to which it is secured. The outer diameter of the (upper end of the) tubular concrete foundation may be in the range 7 m to 14 m.

The (upper end of the) wall of the tubular concrete foundation may have a thickness in the range 0.7 m to 1 m, for instance 0.7 m to 0.8 m.

The thickness of the wall of the tubular concrete foundation may vary along its length. The wall may be thicker at the upper end of the foundation to provide a wider region for the cable head ring to be mounted on. The increased wall thickness at the upper end of the foundation may be in the form of a rim or a flange for the cable head ring to be mounted on.

The concrete foundation may comprise a fixed foundation structure. The fixed foundation structure may be located offshore and rigidly anchored to the sea floor. Hence, the wind turbine assembly may be a fixed foundation offshore wind turbine assembly.

Alternatively, the concrete foundation may comprise a floating foundation, for example a spar platform, a semi-submersible platform, or a barge. Hence, the wind turbine assembly may be floating offshore wind turbine. The floating foundation may be tethered to the sea floor by a mooring system. The mooring system may comprise three or more anchor lines, e.g. anchor chains.

The tubular concrete foundation may comprise one or more portion(s) having a constant diameter along its length. A constant diameter portion may be located at the upper end of the tubular concrete foundation.

The tubular concrete foundation may comprise a cylindrical portion having a constant radius along its length. The tubular concrete foundation may comprise a one or more tapered portion(s), e.g. frustoconical portion(s). The tubular concrete foundation may comprise a cylindrical portion and a frustoconical portion located at an upper end of the cylindrical portion. In this way, the tubular concrete foundation may taper towards its upper end. The upper end of the tubular concrete foundation (i.e. the upper end of the frustoconical portion) may have an outer diameter that is approximately (e.g. +/−0.5 m) the same as the outer diameter of the wind turbine component to which it is secured. The upper end of the frustoconical portion may have an outer diameter in the range 7 m to 14 m. The outer diameter of the cylindrical portion may be greater than the upper diameter of the frustoconical portion, for instance it may have an outer diameter in the range 10 m to 20 m.

Any suitable fastener may be used to secure the wind turbine component to the cable head ring. For example, the fasteners may comprise bolts or expansion anchors. The fasteners may be made of steel.

Where bolts are used, the bolts may be secured in place by nuts. Threaded sections of the bolts may extend radially inwards of the inner tubular web and/or radially outwards of the outer tubular web, and nuts may be fastened on these inwardly and/or outwardly extending portions to secure the bolts in place.

Where expansion anchors are used, they may be secured in place by expanding the anchor within the respective holes so that they compress against the material of the inner web, outer web and the wind turbine component forming the holes (i.e. the inner surfaces of the holes). In this way, the expansion anchors can be secured in the respective holes by frictional forces. An expansion anchor may include an expansion sleeve and an expander for expanding the sleeve outwardly.

An example expansion anchor is a wedge connector. A wedge connector may include an expansion sleeve surrounding two wedge shaped expanders threadedly engaged on a threaded fastener. The wedge-shaped expanders may be arranged so that their narrow ends face each other. The wedge connector may be arranged such that when torque is applied to the threaded fastener, the expanders are brought together forcing the wide ends of the expanders against the expansion sleeve and expanding the expansion sleeve. A suitable wedge connector is produced by C1 Connections BV of Zuid Hollandlaan 7, 2596 AL, Den Haag, Netherlands.

The wind turbine assembly may comprise one or more protective cover(s) arranged to protect the fasteners from environmental conditions. The protective cover(s) may be arranged on the outer surface of the cable head ring (e.g. the outer tubular web) covering the holes in the outer tubular web. The protective cover(s) may seal the holes in the outer tubular web (and the fasteners) against external environmental conditions. The protective cover may comprise a ring attached to an external surface of the cable head ring (e.g. the outer tubular web).

According to a third aspect, the invention provides a method of connecting a tubular wind turbine component to a tubular concrete foundation. The method comprises: providing a tubular concrete foundation having tensioning tendons protruding from the upper end thereof; mounting a cable head ring on the upper end of the concrete foundation so that the tendons protruding from the upper end of the concrete foundation pass through passages that extend axially through the cable head ring; securing the tendons to the cable head ring using anchors, thereby securing the cable head ring to the concrete foundation; inserting a (lower end of a) tubular wind turbine component into an annular gap formed between inner and outer tubular portions of the cable head ring; and securing the tubular wind turbine to the cable head ring by passing fasteners radially through the inner tubular portion of the cable head ring, the wind turbine component, and the outer tubular portion of the cable head ring.

The inner and outer tubular portions may have holes that extend radially therethrough. Preferably, the positions of the holes in the inner tubular portion correspond to the positions of the holes in the outer tubular portion such that a fastener can extend radially through a hole in the inner tubular portion and a hole in the outer tubular portion.

Each hole in the inner tubular portion or each hole in the outer tubular portion may be aligned with a respective hole in the other of the outer tubular portion or the inner tubular portion such that a single fastener can extend radially (i.e. along a radius of the cable head ring) through both a hole in the inner tubular portion and a hole in the outer tubular portion. For example, for n holes in the inner tubular portion, there would be n corresponding holes in the outer tubular portion so that n fasteners could each extend through a hole in the inner tubular portion and a corresponding hole in the outer tubular portion, respectively.

Each hole in the inner tubular portion may correspond to a hole in the outer tubular portion. Each hole in the outer tubular portion may correspond to a hole in the inner tubular portion. Put another way, the number of holes in the inner tubular portion may equal (i.e. no more and no less than) the number of holes in the outer tubular portion, and each hole in the inner tubular portion may correspond to a hole in the outer tubular portion.

The tubular wind turbine component may have holes that extend radially therethrough. The holes in the tubular wind turbine component may correspond with the holes in the inner and outer tubular portions of the cable head ring. The holes in the tubular wind turbine component are preferably located such that they can be inserted into the annular gap between the inner and outer tubular portions of the cable head ring.

It will be appreciated that the holes in the inner tubular portion, the holes in the tubular wind turbine component, and the holes in the outer tubular portion are fastener receiving holes suitable for receiving fasteners therethrough.

Each hole in the tubular wind turbine component may correspond to a hole in the inner tubular portion and/or a hole in the outer tubular portion. Put another way, the number of holes in the tubular wind turbine component may equal (i.e. no more and no less than) the number of holes in the outer tubular portion and/or the number of holes in the inner tubular portion.

Securing the tubular wind turbine to the cable head ring may comprise passing fasteners radially through respective holes in the inner tubular portion, the wind turbine component, and the outer tubular portion. Securing the tubular wind turbine to the cable head ring may comprise passing a fastener through one of the holes in the inner tubular portion, a respective hole in the tubular wind turbine component and a respective hole in the outer tubular portion. In other words, securing the tubular wind turbine to the cable head ring may comprise passing a fastener through corresponding sets of holes in the inner tubular portion, the tubular wind turbine component and the outer tubular portion. The tubular wind turbine component may be considered secured to the cable head ring when each set of holes has a fastener passing therethrough.

The method may utilise the cable head ring of the first aspect. Hence, according to another aspect, the invention provides a method of connecting a tubular wind turbine component to a tubular concrete foundation, the method comprising: providing a tubular concrete foundation having tensioning tendons protruding from the upper end thereof; mounting a cable head ring of the first aspect on the upper end of the concrete foundation so that the tendons protruding from the upper end of the concrete foundation pass through the passages in the annular plate; securing the tendons to the cable head ring using anchors, thereby securing the cable head ring to the concrete foundation; inserting a (lower end of a) tubular wind turbine component into the annular gap between the inner and outer tubular webs, the tubular wind turbine component having holes extending radially therethrough and corresponding with the holes in the inner and outer tubular webs; and securing the tubular wind turbine to the cable head ring by passing fasteners radially through respective holes in the inner tubular web, the wind turbine component, and the outer tubular web.

The cable head ring may include any one or more or all of the optional features described above in respect of the first aspect.

The methods discussed above may be used to provide a wind turbine assembly of the second aspect. Hence, the methods may provide a wind turbine assembly having any one or more or all of the optional features described above in respect of the second aspect.

A layer of grout may be applied to the upper end of the concrete foundation and levelled to provide a level planar surface, before the cable head ring is mounted on the upper end of the concrete foundation. The grout may be cured (e.g. left to set) before the cable head ring is mounted on the foundation.

Mounting the cable head ring on the upper end of the concrete foundation may comprise bringing a lower (planar) surface of the annular plate into contact with the upper end of the concrete foundation (or the layer of grout).

Mounting the cable head ring on the upper end of the concrete foundation may comprise supporting the cable head ring above the upper end of the concrete foundation to form a gap between the cable head ring and the upper end of the concrete foundation, and filling the gap with grout. This will prevent gaps between the concrete foundation and the cable head ring. A tubular barrier may be formed around the gap to form an enclosed volume, which is then filled with grout.

A tubular barrier may be formed extending from the concrete foundation and around a (lower) portion of the cable head ring (e.g. the annular plate and/or a lower portion of the tubular webs) to form a volume, and the volume may be filled with grout. The volume may encompass the gap formed between the cable head ring and the concrete structure. In this way, a portion of the cable head ring can be surrounded by grout.

the tendons may be tensioned to apply a compressive force to the concrete structure. This may be achieved by pulling the end of the tendons away from the concrete foundation.

The anchors for securing the tendons may be arranged on an upwardly facing surface of the cable head ring (e.g. the upper side of the annular plate). The anchors may press against the surface (e.g. the upper side of the annular plate), in this way helping to secure the cable head ring to the concrete foundation.

The (lower end of the) wind turbine component may be inserted into the annular gap (between the inner and outer tubular webs) after the tendons have been secured by the anchors. This ensures that the cable head ring is securely connected to the concrete foundation (through the action of the tendons and the anchors) before the wind turbine component is secured to the cable head ring.

Inserting the wind turbine component into the annular gap may comprise lowering the (lower portion of the) wind turbine component into the annular gap. Optionally, the wind turbine component is lowered into the annular gap so the lower end of the wind turbine component rests against ledge(s) extending into the annular gap (from the inner and/or outer webs).

The holes in the wind turbine component may be aligned with the holes in the inner and outer webs before the tubular wind turbine component is secured to the cable head ring by passing fasteners through the holes. This may comprise adjusting the axial position of the wind turbine component (e.g. raising and/or lowering) and/or rotating the wind turbine component.

Securing the tubular wind turbine component to the cable head ring may comprise passing bolts through the holes in the inner web, wind turbine component and outer web and securing them in place using nuts.

Securing the tubular wind turbine component to the cable head ring may comprise passing expansion anchors thorough the holes in the inner web, wind turbine component and outer web and securing them in place. In order to secure the expansion anchors in place an expander may be forced into an expansion sleeve to force the expansion sleeve to expand outwardly and compress against the material of the inner web, outer web and the wind turbine component forming the holes (i.e. the inner surface of the holes). In this way, the expansion anchors can be secured in the respective holes by frictional forces. Forcing the expander into the expansion sleeve may comprise applying a torque to a threaded fastener of the expansion anchor.

Providing a tubular concrete foundation may comprise forming the concrete foundation, for example using a slip forming method. The concrete foundation may be formed as a monolithic structure.

Certain embodiments of the present invention will now be described by way of example only and with reference to the accompanying drawings, in which:

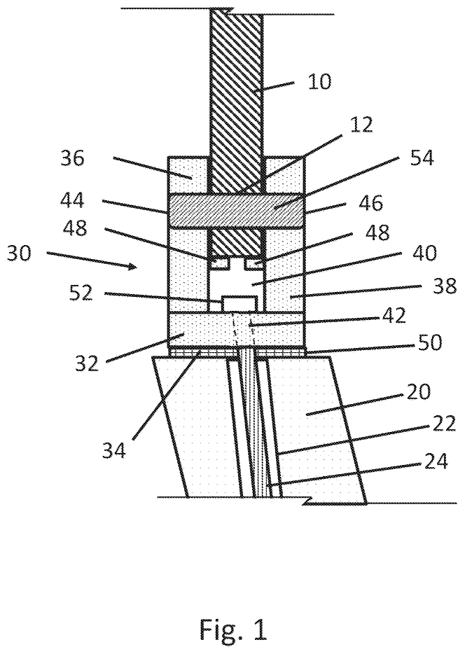

FIG. 1 is a schematic cross-sectional view through a connection assembly for connecting a wind tubular turbine component to a tubular concrete foundation;

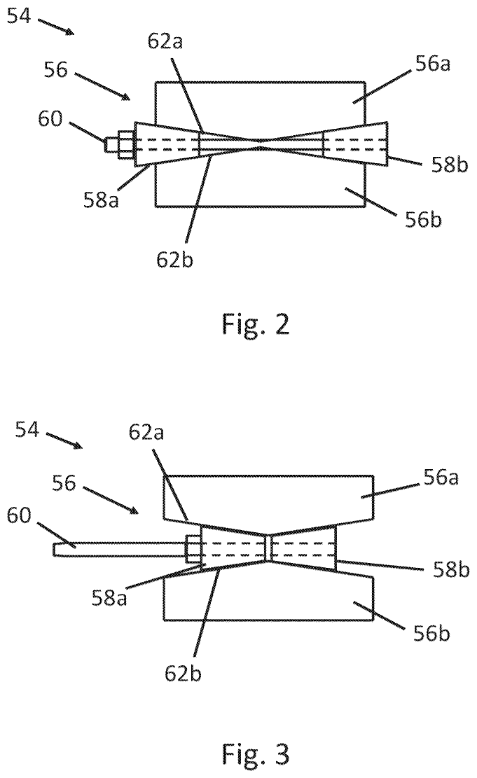

FIG. 2 shows an expansion anchor in a non-expanded state;

FIG. 3 shows the expansion anchor of FIG. 2 in an expanded state;

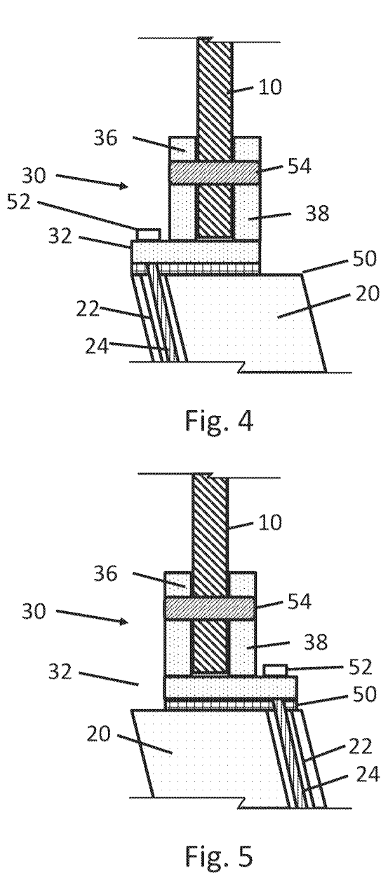

FIG. 4 is a schematic cross-sectional view through another connection assembly for connecting a wind tubular turbine component to a tubular concrete foundation;

FIG. 5 is a schematic cross-sectional view through another connection assembly for connecting a wind tubular turbine component to a tubular concrete foundation; and

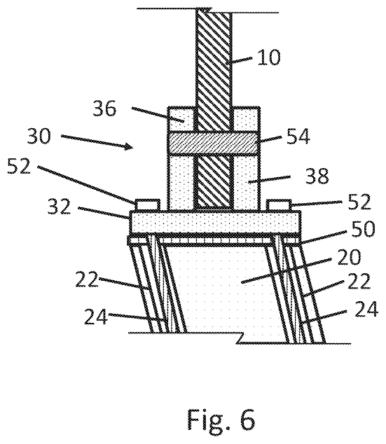

FIG. 6 is a schematic cross-sectional view through yet another connection assembly for connecting a wind tubular turbine component to a tubular concrete foundation.

FIG. 1 shows a cross-section through a part of the lower end of a tubular wind turbine tower 10 connected to the upper end of a floating concrete spar platform 20. The connection is achieved through the use of a cable head ring 30 that is secured to both the spar platform 20 and the wind turbine tower 10.

The spar platform 20 has a classic spar buoy shape, i.e. an elongate, tubular column. The upper end of the spar platform 20 includes a frustoconical portion that has a radius at its upper end that is smaller than a radius at its lower end. As a result, a portion of the spar platform at its upper end tapers towards its upper end. Whilst the spar platform 20 shown in FIG. 1 has a tapered end, the following discussion is also applicable for spar platforms (and other foundation structures) having an upper end portion with a constant outer diameter (i.e. not tapered).

The spar platform 20 is made of prestressed concrete. It comprises a concrete substructure with a number of ducts 22 extending axially therethrough. The ducts 22 are circumferentially spaced around the concrete substructure. One of the ducts 22 can be seen in the cross-section shown in FIG. 1. The ducts 22 may be evenly spaced around the concrete substructure.

Steel tensioning tendons 24 extend through the ducts and protrude from an upper end of the spar platform 20. The tendons 24 can be used to apply a compressive force to the concrete substructure in order to strengthen the concrete substructure against tensile forces.

The cable head ring 30 is made of steel and includes an annular plate 32 that defines a planar mating surface 34 for mounting on the upper end of the spar platform 20. A radially inner tubular web 36 and a radially outer tubular web 38 extend axially from the upper surface (i.e. the surface opposite to the mating surface) of the annular plate 32.

The inner web 36 and the outer web 38 are arranged as concentric tubes, with the inner web 36 having a smaller radius than the outer web 38. An annular gap 40 is formed between the inner and outer webs 36, 38 for receiving a lower end portion of the tower 10. This gives the cable head ring 30 a substantially U-shaped cross-section

A number of passages 42 are formed through the annular plate 32 for receiving the ends of the tendons 24 protruding upwards from the upper end of the spar platform 20. The passages 42 are positioned to correspond with the positions of the ducts 22 in the spar platform 20 so that the tendons 24 can be easily passed through the passages 42. In the assembly shown in FIG. 1, the passages 42 are arranged in the annular plate 32 between the inner and outer webs 36, 38. Hence, the passages 42 are located within the annular gap 40 between the webs 36, 38. The passages 42 are circumferentially spaced around the annular plate 32 to correspond with the locations of the tendons 24.

The cable head ring 30 is mounted on the upper end of the spar platform 20 so that the tendons 24 pass through respective passages 42 in the annular plate 32. A layer of grout 50 is applied between the planar surface 34 (i.e. the underside of the annular plate 32) and the upper surface of the spar platform 20 to provide a level planar surface for the cable head ring 30 to mate with. The grout 50 can be applied to the upper end of the spar platform 20 and levelled in order to account for any undulations or imperfections in the upper surface of the spar platform 20, thereby avoiding or reducing the presence of gaps between the upper end of the spar platform 20 and the planar surface 34 of the cable head ring 30 which could lead to uneven loading on the cable head ring 30 and uneven stress concentration within the material of the cable head ring 30.

Upper ends of the tendons 24 are locked in place by respective tension anchors 52. An anchor 52 is mounted on the end of each tendon 24 on the upper side of the annular plate 32. Tension is applied to the tendons 24, e.g. by pulling the tendons 24 through the respective anchors 52, and the anchors 52 are used to lock the tendon 24 to the cable head ring 30, locking-in the tension and applying a compressive force to the concrete substructure of the spar platform 20.

The cable head ring 30 provides a convenient seat for the tensioning anchors 52. The tension within the tendons 24 acts to pull the anchors 52 against the upper surface of the annular plate 32, thereby securing the cable head ring 30 to the upper end of the spar platform 20.

Radially extending holes are provided through the inner and outer webs 36, 38 to facilitate securing the tower 10 to the cable head ring 30.

The inner web 36 comprises a number of holes 44 that extend radially therethrough. The holes 44 are evenly spaced circumferentially around the inner web 36 and are arranged in a level (horizontal) plane parallel with the planar surface 34 of the annular plate 32. Hence, the holes 44 are arranged in a level ring around the inner web 36.

The outer web 38 comprises a corresponding number of holes 46 that extend radially through the outer web 38. The locations of the holes 46 in the outer web correspond with the locations of the holes 44 in the inner web 36 so that a fastener may extend radially through a hole 44 in the inner web 36 and a hole 46 in the outer web 38. That is, the location of each hole 46 in the outer web 38 corresponds to the location of a respective hole 44 in the inner web 36 so that a fastener for securing the tower 10 in place can pass through a hole 44 in the inner web 36 and a hole 46 in the outer web 38 in a level (horizontal), radial direction. Hence, the holes 46 are arranged in a level ring around the outer web 38, corresponding to the arrangement of the holes 44 in the inner ring 36.

As can be seen in FIG. 1, a lower end of the tower 10 is received within the annular gap 40 between the inner and outer webs 36, 38 so that there is a portion of the tower 10 that overlaps with the inner and outer webs 36, 38. A number of radially extending holes 12 are provided through the tower 10 within this region of overlap for use in securing the tower 10 to the cable head ring 30. The holes 12 in the tower 10 correspond to the holes 44, 46 in the inner and outer webs 36, 38 so that the holes 12 can be aligned with the holes 44, 46 in the inner and outer webs 36, 38. Accordingly, when the holes 12 in the tower 10 are aligned with the holes 44, 46 in the inner and outer webs 36, 38 a fastener can extend radially through a hole 44 in the inner web 36, a hole 12 in the tower 10 and a hole 46 in the outer web 38.

In order to secure the tower 10 the cable head ring 30 (and therefore the spar platform 20), the lower end of the tower 10 is received within the annular gap 40 and the holes 12 in the tower 10 are aligned with the holes 44, 46 in the inner and outer webs 36, 38. It will be appreciated that when aligned, the holes 12, 44, 46 will form passages extending radially through the inner web 36, the tower 10 and the outer web 38. Expansion anchors 54 are provided within these radial passages and secured in place in order to fasten the tower 10 to the cable head ring 30.

The inner and outer webs 36, 38 comprise ledges 48 that extend into the annular gap 40 for the lower end of the tower 10 to rest on. The ledges 48 are positioned so that when the lower end of the tower 10 rests on the ledges 48 the holes 12 in the tower 10 are axially aligned with the holes 44, 46 in the inner and outer webs 36, 38. This can help when aligning the holes 12, 44, 46 during assembly. The ledges 48 may also help to support the tower 10 to relieve vertical stresses placed on the fasteners 54 by the tower 10. Moreover, the ledges 48 prevent the tower 10 from resting on the anchors 52, which may damage the anchors 52 and/or the tendons 24.

An example expansion anchor 54 is shown in FIGS. 2 and 3. It comprises an expansion sleeve 56 formed of two blocks 56a and 56b surrounding two wedge-shaped expanders 58a, 58b arranged with their narrow ends facing each other. The expanders 58a, 58b are threadedly engaged with a threaded fastener 60 so that when a torque is applied to the fastener 60 the wedge-shaped expanders 58a, 58b are brought closer together.

The blocks 56a, 56b are coupled to each other so as to permit relative movement in a direction perpendicular to the longitudinal axis of the threaded fastener 60 (i.e. a radial direction). Each block 56a, 56b includes a V-shaped mating face 62a, 62b that tapers from a central point towards the longitudinal ends of the blocks 56a, 56b. The mating faces 62a, 62b engage with the expanders 58a, 58b such that when the expanders 58a, 58b are brought closer together they force the blocks 56a, 56b further apart.

FIG. 2 shows the expansion anchor 54 in its unexpanded state, and FIG. 3 shows the expansion anchor 54 in an expanded state after torque has been applied to the fastener 60. When an anchor 54 is expanded within the holes 44, 46, 12 the sleeve 56 will compress against the material of the inner web 36, the outer web 38 and the wind turbine component 10 forming the holes 44, 46, 12 to secure the anchor 54 in place by frictional forces.

A suitable expansion anchor of the type described above is produced by C1 Connections BV of Zuid Hollandlaan 7, 2596 AL, Den Haag, Netherlands.

The holes 12, 44, 46 are suitably shaped to receive the expansion anchors 54. In the assembly illustrated in FIG. 1, the holes are elongated holes for receiving the expansion anchors 54. It will however be appreciated that other types of fasteners may be used to secure the tower 10 to the cable head ring 30. For instance, bolts may be used and secured in place with nuts. The holes 12, 44, 46 may be shaped differently depending on the type of fasteners used.

A method of securing a wind turbine tower 10 to a concrete spar platform 20 will now be described.

The spar platform 20 is first assembled in port to an operational condition. This may include manufacturing the concrete platform 20 using a slip forming method.

Once the spar platform 20 has been approved for deployment, a layer of grout 50 is applied to the upper end of the spar platform 20 and levelled to provide a level planar surface for the cable head ring 30 to be mounted to.

The cable head ring 30 is then lifted into position onto the upper end of the spar platform 20 so that the tendons 24 protruding from the upper end of the spar platform 20 pass through the passages 42 in the planar surface 34. The planar surface 34 of the cable head ring 30 is brought into contact with the grout 50 so that the cable head ring rests on the grout 50.

With the cable head ring 30 in position on the spar platform 20, the tension anchors 52 are fitted to the tendons 24 on the upper side of the annular plate 32 before the tendons 24 are tensioned and then secured to the cable head ring 30 by the anchors 52. This acts to compress the concrete substrate of the spar platform 20 and also secure the cable head ring 30 to the spar platform 20.

Once the cable head ring 30 has been secured to the spar platform 20, the tower is lifted and brought into position above the spar platform 20 before being lowered so that the end of the tower 10 is received within the annular gap 40. The position of the tower 10 may need to be adjusted so that the holes 12 in the tower 10 align with the holes 44, 46 in the inner and outer webs 36, 38. This may require raising the tower 10, lowering the tower 10 and/or rotating the tower 10 about its longitudinal axis.

When the holes 12 in the tower 10 are aligned with the holes 44, 46 in the inner and outer webs 36, 38, expansion anchors 54 are installed in the holes 12, 36, 38 before being expanded and secured in place.

In the example illustrated in FIG. 1, the anchors 52 are located within the annular gap between the inner and outer webs 36, 38. Whilst this can act to protect the anchors 52 (and the ends of the tendons 24) from the external environment (e.g. from weathering etc.), it may be difficult to fasten the anchors in place in this location. This is because it may be difficult to position or manoeuvre tools and equipment used for securing the anchors within the annular gap 40. It can also be difficult or even impossible to inspect or maintain the anchors 52 within the annular gap 40 once the tower 10 has been manoeuvred into position and secured to the cable head ring 30.

The assemblies shown in FIGS. 4, 5 and 6 have been designed to address these issues. Many of the components of the assemblies shown in FIGS. 4-6 are identical to those discussed above in respect of FIG. 1, so a description of these components will not be repeated. The assemblies shown in FIGS. 4-6 differ from that shown in FIG. 1 by way of the passages 42 in the annular plate 32, the ducts 22, the tendons 24 and the anchors 52 being located at different positions.

FIG. 4 shows a spar platform 20 in which the upper ends of the ducts 22 are located at the radially inner side of the concrete substrate. As a result, the tendons 24 running through the ducts 22 protrude from a radially inner portion of the upper end of the spar platform 20.

The annular plate 32 of the cable head ring 30 extends radially inwards of the inner tubular web 36, forming an inwardly projecting flange. The passages 42 are formed through the flange for receiving the tendons 24 and anchors 52 are mounted on the end of each tendon 24 on the upper side of the flange to secure the tendons 24 in place. The lower end of the tower 10 may rest on the upper surface of the annular plate, i.e. there may be no ledges 48.

This assembly functions similarly to the assembly shown in FIG. 1, but the anchors are not located within the annular gap 40. Rather, the anchors 52 are located on the upper side of a flange that extends radially inwards. This can make it easier to fasten the anchors 52 in place during assembly, and also easier to inspect and maintain the anchors 52 during operation of the wind turbine. Since the anchors 52 are located within the interior of the tubular structure, assembly and maintenance can be performed more safely by personnel from within the tubular structure. The anchors 52 will also be protected from the external environment.

FIG. 5 shows a spar platform 20 in which the upper ends of the ducts are located at the radially outer side of the concrete substrate. As a result, the tendons 24 running through the ducts 22 protrude from a radially outer portion of the upper end of the spar platform 20.

The annular plate 32 of the cable head ring 30 extends radially outwards of the outer tubular web 38, forming an outwardly projecting flange. The passages 42 are formed through the flange for receiving the tendons 24 and anchors 52 are mounted on the end of each tendon 24 on the upper side of the flange to secure the tendons 24 in place. The lower end of the tower 10 may rest on the upper surface of the annular plate, i.e. there may be no ledges 48.

This assembly functions similarly to the assemblies shown in FIGS. 1 and 4, but the anchors are located on the upper side of a flange that extends outwardly of the outer web 38. Compared to the assembly shown in FIG. 1, this can make it easier to fasten the anchors 52 in place during assembly. It may also be easier to inspect and maintain the anchors 52 during operation of the wind turbine. This assembly may also provide for a stronger connection between the cable 30 head ring and the spar platform 20 compared to the assembly shown in FIG. 4.

In the assemblies shown in FIGS. 4 and 5, the forces exerted on the cable head ring 30 by the tendons 24 (and anchors 52) may not be spread evenly across the cable head ring 30. The assembly shown in FIG. 6 has been proposed to address this.

The assembly shown in FIG. 6 includes an annular plate 32 that extends radially inwards of the inner tubular web 36 and radially outwards of the outer tubular web 38. This forms a flange that projects inwardly and outwardly of the tubular webs 36, 38. In this way, tendons 24 can be anchored to the cable head ring 30 on an inner side of the inner web 36 as well as on an outer side of the outer web 38. Accordingly, the loads on the cable head ring 30 can be more evenly distributed.

The spar platform 20 includes ducts 22 that have upper ends located at the radially inner side of the concrete substrate and ducts 22 that have upper ends located at the radially outer side of the concrete substrate. Thus, tendons 24 protrude from a radially inner portion and a radially outer portion of the upper end of the spar platform 20 and extend through the passages 42 in the cable head ring 30.

Whilst in the assemblies and methods described above a wind turbine tower 10 is connected to a floating spar platform 20 to provide a floating offshore wind turbine, the assembly techniques can also be applied to other tubular concrete foundations. This may include offshore fixed-foundations, or indeed onshore foundations.

1. A cable head ring for use in connecting a wind turbine tower to a concrete foundation, the cable head ring comprising:
an annular plate for connecting to the upper end of a concrete foundation, the annular plate comprising a plurality of passages extending axially therethrough for receiving tensioning tendons of the concrete foundation;
an inner tubular web extending axially from the annular plate; and
an outer tubular web extending axially from the annular plate, the outer tubular web having a larger radius than the inner tubular web so that an annular gap is formed between the inner and outer tubular webs for receiving a tubular wind turbine component;
wherein the inner tubular web includes holes extending radially therethrough, and the outer tubular web includes holes extending radially therethrough, and
wherein the positions of the holes in the inner tubular web correspond to the positions of the holes in the outer tubular web such that a fastener can extend radially through a hole in the inner tubular web and a hole in the outer tubular web for securing a tubular wind turbine component within the annular gap.

2. A cable head ring according to claim 1, wherein the holes in the inner tubular web and/or the outer tubular web are circumferentially spaced around the respective web.

3. A cable head ring according to claim 1, wherein one or more of the passages through the annular plate are located between the inner and outer tubular webs.

4. A cable head ring according to claim 1, wherein the annular plate extends radially inward of the inner tubular web, and one or more of the passages through the annular plate is located radially inward of the inner tubular web; and/or
wherein the annular plate extends radially outward of the outer tubular web, and one or more of the passages through the annular plate is located radially outward of the outer tubular web.

5. A cable head ring according to claim 1, wherein the passages through the annular plate are circumferentially spaced around the annular plate, preferably wherein the passages are evenly spaced around the annular plate.

6. A cable head ring according to claim 1, wherein the cable head ring is made of steel.

7. A wind turbine assembly comprising;
a tubular concrete foundation having tensioning tendons protruding from the upper end thereof;
a cable head ring according to any preceding claim mounted on the upper end of the concrete foundation, the tensioning tendons passing through the passages in the annular plate and being secured by anchors arranged on an upper surface of the annular plate;
a tubular wind turbine component received within the annular gap between the inner and outer tubular webs of the cable head ring, the wind turbine component comprising holes extending radially therethrough and corresponding with the holes in the inner and outer tubular webs; and
fasteners extending radially through respective holes in the inner tubular web, the wind turbine component, and the outer tubular web to secure the wind turbine component to the cable head ring.

8. A wind turbine assembly according to claim 7, wherein the fasteners comprise bolts or expansion anchors.

9. A wind turbine assembly according to claim 7, wherein a layer of grout is provided between the cable head ring and the concrete foundation, preferably wherein the layer of grout comprises a level planar upper surface for the cable head ring to be mounted thereon.

10. A wind turbine assembly according to claim 7, wherein the tensioning tendons are circumferentially spaced around the tubular concrete foundation, optionally evenly spaced around the tubular concrete foundation.

11. A wind turbine assembly according to claim 7. wherein one or more of the tendons extend through respective passages in the annular plate that are located between the inner and outer tubular webs.

12. A wind turbine assembly according to claim 7, wherein one or more of the tendons extend through respective passages in the annular plate that are located radially inward of the inner tubular web.

13. A wind turbine assembly according to claim 7. wherein one or more of the tendons extend through respective passages in the annular plate that are located radially outward of the outer tubular web.

14. A wind turbine assembly according to claim 7, wherein the concrete foundation comprises a floating foundation, optionally a spar platform.

15. A wind turbine assembly according to claim 7, wherein the tubular wind turbine component is made of steel.

16. A wind turbine assembly according to claim 7, wherein the tubular wind turbine component comprises a tubular wind turbine tower; or
the tubular wind turbine component comprises a tower extension piece, optionally wherein the tower extension piece is secured to a wind turbine tower.

17. A wind turbine assembly according to claim 16, wherein a nacelle is mounted on the wind turbine tower, and one or more rotor blades is mounted to the nacelle via a rotor hub.

18. A method of connecting a tubular wind turbine component to a tubular concrete foundation, the method comprising:
providing a tubular concrete foundation having tensioning tendons protruding from the upper end thereof;
mounting a cable head ring on the upper end of the concrete foundation so that the tendons protruding from the upper end of the concrete foundation pass through passages that extend axially through the cable head ring;
securing the tendons to the cable head ring using anchors, thereby securing the cable head ring to the concrete foundation;
inserting a tubular wind turbine component into an annular gap formed between inner and outer tubular portions of the cable head ring; and
securing the tubular wind turbine to the cable head ring by passing fasteners radially through the inner tubular portion, the wind turbine component, and the outer tubular portion.

19. A method according to claim 18, comprising applying a layer of grout to the upper end of the concrete foundation before mounting the cable head ring on the upper end of the concrete foundation, optionally wherein the layer of grout is levelled to provide a level planar surface before mounting the cable head ring on the upper end of the concrete foundation.

20. A method according to claim 18, comprising tensioning the tendons to apply a compressive force to the tubular concrete structure.
